(19) United States
(12) Patent Application Publication
(10) Pub. No.: US 2009/0017194 A1
(43) Pub. Date: Jan. 15, 2009

(54) Process of Making Carbon-Coated Lithium Metal Polyanionic Powders

(75) Inventors: Zhenhua Mao, Ponca City, OK (US); Edward J. Nanni, Ponca City, OK (US); Eric T. Lind, Victor, NY (US)

Correspondence Address: ConocoPhillips Company - IP Services Group;Attention: DOCKETING, 600 N. Dairy Ashford, Bldg. MA-1135, Houston, TX, 77079, US

(73) Assignee: CONOCOPHILLIPS COMPANY, Bartlesville, OK (US)

(21) Appl. No.: 12/088,324

(22) PCT Filed: Jan. 9, 2007
(86) PCT No.: PCT/US07/60292

§ 371 Date: Sep. 26, 2008

Related U.S. Application Data
(63) Continuation of application No. 11/327,972, filed on Jan. 9, 2006.

(51) Int. Cl. B05D 5/12

(52) U.S. Cl. 427/77

(57) ABSTRACT

The present invention provides a process for making a battery cathode material with improved properties in lithium ion batteries. In one embodiment, the process comprises synthesizing a lithium metal polyanionic (LMP) powder. The process further comprises precipitating a carbonaceous coating on to the LMP powder to form a coated LMP powder. Additionally, the process comprises stabilizing and then carbonizing the coated LMP powder to produce the battery cathode material. The charge capacity, coulombic efficiency, and cycle life of the battery cathode material is better than those of the uncoated LMP powder.

This application claims priority to U.S. patent application Ser. No. 11/327,972 filed Jan. 9,2006.

### STATEMENT REGARDING FEDERALLY SPONSORED RESEARCH OR DEVELOPMENT

Not applicable.

### BACKGROUND

1. Field of the Invention

This invention relates generally to the field of making carbon-coated powders. More particularly, this invention relates to making carbon-coated lithium metal polyanionic powders.

2. Background of the Invention

Lithium cobalt oxide (LiCoO₂) is currently used as the cathode material for lithium ion batteries. Because LiCoO₂ is expensive, environmentally hazardous, and thermally unstable, the applications of lithium ion batteries are currently limited to portable electronic devices. If an inexpensive and environmentally benign compound can be found to replace LiCoO₂ for lithium ion batteries, lithium ion batteries may become the choice of batteries for many other applications such as power tools and electrical vehicles. Thus, alternative compounds have been investigated to replace LiCoO₂ for applications in lithium battery products which require high charge/discharge rates and moderate to high temperatures.

In particular, alternative lithium containing inorganic compounds have shown promise in replacing LiCoO₂. However, studies have shown that the actual, measured charge capacities of such compounds are less than their theoretical capacities. Improving such battery properties has been typically addressed by making particles ultra fine, doping other elements into the compound, or blending/coating carbon with the compound. These methods involve time-consuming procedures such as sol-gel processes; accordingly, they might not be cost-effective because additional chemicals such as gelling and chelating agents are consumed in addition to the precursors of the compound itself.

Accordingly, there is a need for an economical process for making a battery cathode material. Additional needs include a method of improving the battery properties, such as charge capacity and columbic efficiency, of cathode materials.

### BRIEF SUMMARY

Lithium metal polyanionic (LMP) compounds possess many attractive properties as the cathode material for lithium ion batteries. However, such materials are electronic insulators. Consequently, the battery properties of the material by itself may be insufficient for practical use. Methods for making a battery cathode material and improving its properties are therefore described herein. The methods involve coating a LMP powder with a carbonaceous coating to form a cathode material with improved charge capacity, coulombic efficiency, electronic conductivity, and ionic conductivity. The process for making a battery cathode material overcomes problems in making conventional cathode materials for lithium ion batteries. The process is simple and fast.

These and other needs in the art are addressed in one embodiment by a process for making a battery cathode material. The process comprises providing a LMP powder. The process further comprises precipitating a carbonaceous material on the LMP powder to form a coated LMP powder. Additionally, the process comprises carbonizing the coated LMP powder to produce the battery cathode material, wherein the battery cathode material has electrical conductivity >10-fold that of the respective uncoated material.

In another embodiment, a method of increasing the charge capacity of a LMP powder comprises precipitating a carbonaceous material on the LMP powder to form a coated LMP powder. The method also comprises carbonizing the coated LMP powder to increase the charge capacity of the LMP powder by at least 10%.

In yet a further embodiment, a method of increasing the coulombic efficiency of a LMP powder comprises precipitating a carbonaceous material on the LMP powder to form a coated LMP powder. The method also comprises carbonizing the coated LMP powder to increase the coulombic efficiency of the LMP powder by at least 10%.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a detailed description of the preferred embodiments of the invention, reference will now be made to the accompanying drawings in which:

FIG. 1 is a comparison of the 1st cycle potential profiles for the carbon-coated and uncoated LiFePO₄ powders that were heat treated at different temperatures; and

FIG. 2 illustrates the discharge capacity versus cycle number for carbon-coated and uncoated LiFePO₄ powders that were heat treated at different temperatures; and

FIG. 3 illustrates the capacity and coulombic efficiency of the uncoated lithium vanadium phosphate (LVP) electrodes at different cycles; and

FIG. 4 illustrates the capacity and coulombic efficiency of the carbon-coated LVP (C-LVP) electrodes at different cycles; and

FIG. 5 illustrates the cell voltage profiles at the 1st and 10th cycles for a LVP/Li cell during constant current (CC), then constant voltage (CV) charging and constant current discharging; and

FIG. 6 illustrates the cell voltage profiles at the 1st and 10th cycles for a C-LVP/Li cell during constant current (CC), then constant voltage (CV) charging and constant current discharging; and

FIG. 7 is a comparison of relative capacities at different cycle numbers among uncoated LVP, carbon-coated LVP, and LiCoO₂ electrodes. The “A” in the legend for C-LVP signifies that the carbonaceous-coated substrate was stabilized in air; the “E” signifies stabilization with nitrate ion; and

FIG. 8 illustrates capacity and coulombic efficiency of the uncoated LVP electrodes at different cycles in which no additional carbon black was added to the electrodes; and

FIG. 9 illustrates capacity and coulombic efficiency of the carbon-coated LVP electrodes at different cycles; and

FIG. 10 illustrates capacity and coulombic efficiency of the heat-treated LVP electrodes at different cycles in which no additional carbon black was added to the electrodes; and

FIG. 11 is a comparison of capacities at different cycle numbers amongst uncoated LVP, heat-treated uncoated LVP, and carbon-coated LVP; and

FIG. 12 illustrates the cell voltage profiles at the 1st and 10th cycles for the uncoated-LVP/Li cell during constant current (CC), then constant voltage (CV) charging and constant current discharging in which the LVP electrode does not contain additional carbon black; and

FIG. 13 illustrates cell voltage profiles at the 1st and 10th cycles for heat-treated-LVP during constant current (CC), then constant voltage (CV) charging and constant current discharge. The HT-LVP electrode does not contain additional carbon black; and

FIG. 14 illustrates the cell voltage profiles of the 1st and 10th cycles for a carbon-coated-LVP/Li cell during constant current (CC), then constant voltage (CV) charging and constant current discharging. The electrode does not contain additional carbon black.

### DETAILED DESCRIPTION OF THE PREFERRED EMBODIMENTS

In an embodiment, a battery cathode material may be prepared by: a) providing a lithium metal polyanionic (LMP) powder, b) precipitating a carbonaceous coating on to the LMP powder to form coated LMP powder, and c) carbonizing the coated LMP powder to produce the carbon-coated LMP powder. In an embodiment, the LMP powder may be synthesized. The synthesizing of the LMP powder may be accomplished using any suitable reaction. In some embodiments, the LMP powder may be synthesized via a thermal solid phase reaction with stoichiometric amounts of lithium compounds, metal compounds, and polyanionic compounds. The thermal solid phase reaction may be run at any suitable temperatures. For instance, the temperatures may be between about 200° C. and about 1,000° C., alternatively between about 350° C. and about 850° C. The reaction may be carried out in any suitable conditions. For instance, the reaction may be carried out in inert conditions in the absence of oxygen.

Examples of lithium compounds that may be used include, without limitation, lithium hydroxide, lithium carbonate, lithium acetate, lithium oxalate, other lithium salts, or combinations thereof. Additionally, any suitable metal compounds may be used. In a specific embodiment, the LMP powder comprises a transition metal such as, without limitation, compounds containing iron (Fe), manganese ( ), cobalt (Co), nickel (Hi), copper, vanadium (V), chromium (Cr) or any combination thereof. Examples of metal compounds that may be used include without limitation, metal powder, metal oxalate hydrate, metal acetates, metal oxides, metal carbonate, metal salts, or combinations thereof. It is to be understood that the reference “M” in LMP represents a first transition metal.

Furthermore, any suitable polyanion compounds known to one skilled in the art may be used to synthesize the LMP powders. Typically, the polyanions may contain without limitation, boron (B), phosphorous (P), silicon (Si), Arsenic (As), aluminum (Al), sulfur (S), fluorine (F), chlorine (Cl) or combinations thereof. Examples of such polyanions include, without limitation, BO₃³⁻, PO₄³⁻, SiO₃²⁻, SiO₃³⁻, AsO₃³⁻, AsCl₃⁻, AlO₃³⁻; AlO₂⁻, SO₄²⁻, or combinations thereof Other polyanions that may be used to synthesize the IMP powder include chloride (Cl) oxyanions such as ClO⁻, ClO₂⁻, ClO₃⁻, and the like. Examples of phosphate compounds that may be used include without limitation, ammonium phosphate, phosphoric acid, lithium phosphate, phosphate salts, or combinations thereof. It is to be understood that the reference “P” in LMP represents any suitable polyanion.

Without limitation, examples of LMP powders that may be synthesized include lithium iron phosphate (LiFePO₄), lithium manganese phosphate (LiMnPO₄), lithium nickel phosphate (LiNiPO₄), lithium cobalt phosphate (LiCoPO₄), lithium vanadium phosphate (LiVPO₄), or combinations thereof Further examples of LMP powders that may be synthesized include Li_{w}Mₓ(AO_{y})_{z} where M is any suitable transition metal; A is a metal or non-metal or metalloid, such as P, B, Si, or Al; and w, x, y, and z are integers in the chemical formula such that the resulting compounds are electronically neutral species. Thus, any combination of metal cations and polyanions can be utilized in conjunction with the disclosed processes.

In an embodiment, the particle size of the synthesized LMP powder may be controlled to produce a desired particle size. In particular embodiments, the desired particle size of the LMP powders is less than about 50 microns, preferably less than about 20 microns, more preferably less than about 10 microns. Without being limited by theory, controlling the particle size involves mechanical mixing, milling, spray-drying or any other suitable physical or chemical method.

The LMP powder may be coated with the carbonaceous material by any suitable method. Any useful technique for coating the LMP powder may be used. By way of non-limiting examples, useful techniques include the stops of liquefying the carbonaceous material by a means such as melting or forming a solution with a suitable solvent combined with a coating step such as spraying the liquefied carbonaceous material onto the LMP particles, or dipping the LMP particles in the liquefied carbon residue-forming material and subsequently drying out any solvent. The carbonaceous material may be precipitated on the LMP powder by any suitable method to form the coated LMP powder. In an embodiment, the coated LMP powder may be formed by dispersing the LMP powder in a suspension liquid to form a LMP powder suspension. A carbonaceous solution may then be added to the LMP powder suspension and mixed so that a portion of the carbonaceous material may precipitate on the LMP particles in the carbonaceous-LMP mixture. The carbonaceous solution may be prepared by dissolving a carbonaceous material in a solvent.

A particularly useful method of forming a uniform coating of a carbonaceous material is to partially or selectively precipitate the carbonaceous material onto the surface of the LMP particles. The process is as follows: First, a concentrated solution of the carbonaceous material in a suitable solvent is formed by combining the carbonaceous material with a solvent or a combination of solvents as described above to dissolve all or a substantial portion of the coating material. When petroleum or coal tar pitch is used as the carbon residue-forming material or coating material, e.g., solvents such as toluene, xylene, quinoline, tetrahydrofuran, Tetralin, or naphthalene are preferred. The ratio of the solvent(s) to the carbonaceous material in the solution and the temperature of the solution is controlled so that the carbonaceous material completely or almost completely dissolves into the solvent. Typically, the solvent to carbonaceous material ratio is less than 2, and preferably about 1 or less, and the carbonaceous material is dissolved in the solvent at a temperature that is below the boiling point of the solvent.

Concentrated solutions wherein the solvent-to-solute ratio is less than 2:1 are commonly known as flux solutions. Many pitch-type materials form concentrated flux solutions wherein the pitch is highly soluble when mixed with the solvent at solvent-to-pitch ratios of 0.5 to 2.0. Dilution of these flux mixtures with the same solvent or a solvent in which the carbonaceous material is less soluble results in partial precipitation of the carbonaceous material. When his dilution and precipitation occurs in the presence of a suspension of LMP particles, the particles act as nucleating sites for the precipitation. The result is an especially uniform coating of the carbonaceous material on the particles.

The coating layer of the LMP particles can be applied by mixing the particles into a solution of carbonaceous material directly. When the LMP particles are added to the solution of carbonaceous material directly, additional solvent(s) is generally added to the resulting mixture to effect partial precipitation of the carbonaceous material. The additional solvent(s) can be the same as or different than the solvent(s) used to prepare the solution of tile carbonaceous materials.

In an alternative method to the precipitation method described above, a suspension of LMP particles is prepared by homogeneously mixing the particles in either the same solvent used to form the solution of carbonaceous material, in a combination of solvent(s) or in a different solvent at a desired temperature, preferably below the boiling point of the solvent(s). The suspension of the LMP particles is then combined with the solution of carbonaceous material, causing a certain portion of the carbonaceous material to deposit substantially uniformly on the surface of the LMP particles.

The total amount and chemical composition of the carbonaceous material that precipitates onto the surface of the LMP particles depends on the portion of the carbonaceous material that precipitates out from the solution, which in turn depends on the difference in the solubility of the carbonaceous material in the initial solution and in the final solution. When the carbonaceous material is a pitch, wide ranges of molecular weight species are typically present. One skilled in the art would recognize that partial precipitation of such a material would fractionate the material such that the precipitate would be relatively high molecular weight and have a high melting point, and the remaining solubles would be relatively low molecular weight and have a low melting point compared to the original pitch

The solubility of the carbonaceous material in a given solvent or solvent mixture depends on a variety of factors including, for example, concentration, temperature, and pressure. As stated earlier, dilution of concentrated flux solutions causes solubility of the carbonaceous material to decrease. Precipitation of the coating is further enhanced by starting the process at an elevated temperature and gradually lowering the temperature during the coating process. The carbonaceous material can be deposited at either ambient or reduced pressure and at a temperature of about −5° C. to about 400° C. By adjusting the total ratio of the solvent to the carbonaceous material and the solution temperature, the total amount and chemical composition of the carbonaceous material precipitated on the LMP particles can be controlled.

The amount of carbonaceous material coated on the LMP powder may be varied by changing the amount of solvent used to dissolve the carbonaceous material and the amount of solvent in the carbonaceous-LMP mixture. The amount of solvent used may be any amount suitable to provide a desired coating. In certain embodiments, the weight ratio of carbonaceous material to solvent may be between about 0.1 to about 2, alternatively between about 0.05 and about 0.3, alternatively between about 0.1 and about 0.2. The amount of the carbonaceous material coated on the LMP powder may be between about 0.1% and about 20% by weight, alternatively between about 0.1% and about 10% by weight, and alternatively between about 0.5% and about 6% by weight.

It is to be understood that the carbonaceous material provided as the coating for the LMP may be any material which, when thermally decomposed in an inert atmosphere to a carbonization temperature of 600° C. or greater temperature forms a residue which is “substantially carbon”. It is to be understood that “substantially carbon” indicates that the residue is at least 95% by weight carbon. Preferred for use as coating materials are carbonaceous materials that are capable of being reacted with an oxidizing agent. Preferred compounds include those with a high melting point and a high carbon yield after thermal decomposition. Without limitation, examples of carbonaceous materials include petroleum pitches and chemical process pitches, coal tar pitches, lignin from pulp industry; and phenolic resins or combinations thereof. In other embodiments, the carbonaceous material may comprise a combination of organic compounds such as acrylonitrile and polyacrylonitriles, acrylic compounds, vinyl compounds; cellulose compounds; and carbohydrate materials such as sugars. Especially preferred for use as coating materials are petroleum and coal tar pitches and lignin that are readily available and have been observed to be effective as carbon residue-forming materials.

Any suitable solvent may be used to dissolve the carbonaceous material. Without limitation, examples of suitable solvents include xylene, benzene, toluene, tetrahydronaphthalene (sold by Dupont under the trademark Tetralin), decaline, pyridine, quinoline, tetrahydrofuran, naphthalene, acetone, cyclohexane, ether, water, methyl-pyrrolidone, carbon disulfide, or combinations thereof The solvent may be the same or different than the suspension liquid used to form the LMP powder suspension. Without limitation, examples of liquids suitable for suspension of the LMP powder include xylene, benzene, toluene, Tetralin, decaline, pyridine, quinoline, tetrahydrofuran, naphthalene, acetone, cyclohexane, ether, water, methyl-pyrrolidone, carbon disulfide, or combinations thereof.

Additional embodiments include increasing the temperature of the carbonaceous solution prior to mixing with the LMP powder suspension The carbonaceous solution may be heated to temperatures from about 25° C. to about 400° C., alternatively from about 70° C. to about 300° C. Without being limited by theory, the temperature may be increased to improve the solubility of the carbonaceous material. In an embodiment, the LMP powder suspension and/or the carbonaceous solution may be heated before being mixed together. The LMP powder suspension and carbonaceous solution may be heated to the same or different temperatures. The LMP powder suspension may be heated to temperatures from about 25° C. to about 400° C., alternatively from about 70° C. to about 300° C. In another embodiment, after the LMP powder suspension and the carbonaceous solution are mixed together, the carbonaceous-LMP mixture may be heated. The carbonaceous-LMP mixture may be heated to temperatures from about 25° C. to about 400° C., alternatively from about 70° C. to about 300° C.

The temperature of the carbonaecous-LMP mixture may be reduced so that a portion of the carbonaceous material precipitates on to the LMP powder to form a carbonaceous coating. In particular embodiments, the carbonaceous-LMP mixture may be cooled to a temperature between about 0° C. and about 100° C., alternatively between about 20° C. and about 60° C.

Once coated, the coated LMP powder may be separated from the carbonaceous-LMP mixture by any suitable method. Examples of suitable methods include filtration, centrifugation, sedimentation, and/or clarification.

In certain embodiments, the coated LMP powder may be dried to remove residual solvent on the coated particles. The coated LMP powder may be dried using any suitable method. Without limitation, examples of drying methods include vacuum drying, oven drying, heating, or combinations thereof.

In some embodiments, the coated LMP powder may be stabilized after separation from the carbonaceous-LMP mixture. Stabilization may include heating the coated LMP powder for a predetermined amount of time in a nearly inert (containing less than 0.5% oxygen) environment. Tn an embodiment, the coated LMP powder may be stabilized by raising the temperature to between about 20° C. and 400° C., alternatively between about, 250° C. and 400° C., and holding the temperature between about 20° C. and 400° C., alternatively between about 250° C. and about 400° C. for 1 millisecond to 24 hours, alternatively between about 5 minutes and about 5 hours, alternatively between about 15 minutes and about 2 hours. The stabilization temperature should not exceed the instantaneous melting point of the carbonaceous material. The exact time required for stabilization will depend on the temperature and the properties of the carbonaceous coating.

In a preferred embodiment, the coated LMP powder may be heated in the presence of an oxidizing agent. Any suitable oxidizing agent may be used such as a solid oxidizer, a liquid oxidizer, and/or a gaseous oxidizer. For instance, oxygen and/or air may be used as an oxidizing agent.

The coated LMP powder may then be carbonized. Carbonization may be accomplished by any suitable method. In an embodiment, the coated LMP powder may be carbonized in an inert environment under suitable conditions to convert the carbonaceous coating into carbon. Without limitation, suitable conditions include raising the temperature to between about 600° C. and about 1,100° C., alternatively between about 700° C. and about 900° C., and alternatively between about 800° C. and about 900° C. The inert environment may comprise any suitable inert gas including without limitation argon, nitrogen, helium, carbon dioxide, or combinations thereof Once carbonized, the carbon-coated LMP powders may be used as a battery cathode material in lithium ion batteries or any other suitable use.

The various embodiments of the process described above may also be used to increase the battery properties of a LMP powder. In particular, the battery properties that may be increased or improved include the capacity and the coulombic efficiency of a LMP powder. In one embodiment, the capacity of a LMP powder is increased by at least about 10%, preferably by at least about 15%, more preferably by at least about 20%. In another embodiment, the coulombic efficiency of a LMP powder is increased by at least about 10%, preferably by at least about 12%, more preferably by at least about 15%.

To further illustrate various illustrative embodiments of the present invention, the following examples are provided.

### Example 1

### Lithium Iron Phosphate Powders

Synthesis of LiFePO₄—45.86 g of iron oxalate (FeC₂O₄.2H₂O) from Aldrich was dispersed in 58 ml of phosphoric acid solution (containing 29.29 g of 85.4% H₃PO₄), and 10.917 g of lithium hydroxide (LiOH.H₂O, 98%) was dissolved in 20 ml of water which was then gradually poured into the FeC₂O₄+H₃PO₄ solution and thoroughly mixed together. Water was then evaporated under a nitrogen environment at 200° C. The resulting powder was placed in a furnace and heated at 350° C. for 10 hours and then at 450° C. for 20 hours, both in a nitrogen environment. The powder was removed from the furnace, mixed thoroughly, and placed back in the furnace and heated at 650° C. for 20 hours. The resulting powder was LiFePO₄, labeled as A in the following discussion. This powder was milky white and electrically insulating.

Carbonaceous-coating—20 g of the resulting LiFePO₄ were dispersed in 100 ml of 2 wt % pitch-xylene solution and heated to 140° C. In addition, 10 g of petroleum pitch that has about 10% xylene insoluble content was dissolved in 10 g of xylene. The latter was poured into the LiFePO₄ suspension while it was continuously stirred. The suspension was subsequently heated at 160° C. for 10 minutes and cooled to ambient temperature (˜23° C.). The resulting solid particles were separated by filtration and washed twice with 50 ml of xylene, and then dried under vacuum at 100° C. The resulting dry powder weighed 21.0 g, yielding about 5 wt % of pitch in the powder.

Stabilization and Carbonization—The carbonaceous-coated LiFePO₄ powder was mixed with 5 g of a lithium nitrate solution (containing 0.1 g of LiNO₃), dried and then heated at 260° C. for 2 hours in nitrogen gas. The resulting powder was separated into three samples which were heated in nitrogen gas at 800, 900, or 950° C. for 2 hours, respectively. The resulting powder remained as loose powder. These samples were labeled as B, C, and D, respectively. The resulting powders were carbon-coated LiFePO₄. They were black and electrically conductive. For comparison purposes, 10 g of sample A was heated at 950° C. for 2 hours. After heating, the powder sintered together into a fused entity or chunk. The chunk was ground in a mortar and pestle. The resulting powder, labeled Sample E, was gray white, and electrically insulating.

Electrochemical test—Samples A and E were mixed with 8% acetylene carbon black, 4% graphite powder and then mixed with a polyvinylidene fluoride (PVDF) solution to form a slurry. The resulting slurries were cast on an aluminum (Al) foil using a hand doctor-blade coater. The cast films were dried on a hot plate at 110° C. for 30 minutes. The resulting solid film had a composition of 83% LiFePO₄, 5% PVDF, 8% carbon black and 4% graphite. The films were pressed to a density of about 1.9 g/cc through a hydraulic rolling press.

Samples B, C, and D were similarly fabricated into films as above, but the film compositions were 89% carbon-coated LiFePO₄, 2% carbon black, 4% graphite, and 5% PVDF. The density of the film was also 1.9 g/cc

Disks of 1.65 cm² were punched out from each of the above films and used as the positive electrode in coin cells for electrochemical tests. The other electrodes of the coin cells were lithium (Li) metal. A glass matt and a porous polyethylene film (Cellgard® 2300 commercially available from CellGard Corp.) were used as the separator between the electrode and Li metal foil. Both the electrodes and separator were soaked with 1 M LiPF₆ electrolyte. The solvent for the electrolyte consisted of 40 wt % ethylene carbonate, 30 wt % diethyl carbonate, and 30 wt % dimethyl carbonate. The cells were charged and discharged under constant currents between 4.0 and 2.5 volt to determine electrochemical properties of the positive electrode materials.

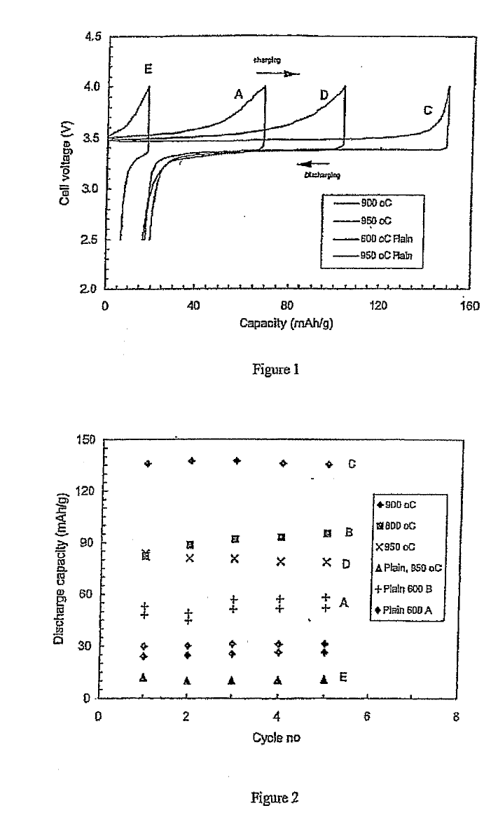

Two of the most important properties are the gravimetric capacity of the positive electrode material and the stability of the gravimetric capacity during repeated charging/discharging cycles. FIGS. 1 and 2 show comparisons of the LiFePO₄ materials as prepared above. FIG. 1 shows a comparison of the electrode potentials as a function of charged and discharged capacity for four materials. For sample A, its electrode potential reached 4.0 volt after a capacity of about 70 mAh/g had been charged into the electrode, but the potential dropped to 2.5 volts after a capacity of about 50-55 mAh/g had been discharged from the electrode. Sample E had a very small charge and discharge capacity (about 10 mAh/g only). However, samples B, C, and D had much better capacity than A, as shown in both FIGS. 1 and 2. For example, sample C had a discharge capacity of about 140 mAh/g.

FIGS. 1 and 2 also show that the carbonization temperature had a significant effect on the carbon-coated LiFePO₄ powders. Based on these results, the preferred carbonization temperature would be between 700 and 900° C. Such prepared carbon-coated LiFePO₄ powders were very stable during charge/discharge cycling. As shown in FIG. 2, the capacity of the materials remained constant with cycle number.

### Example 2

### Lithium Vanadium Phosphate Powders

### A. Material Preparation

Lithium vanadium phosphate (LVP) powder was obtained from Valence Technology, Inc (Austin, Tex.). Two batches of LVP powder (20 and 500 g each, respectively) were coated with 5% pitch using the carbonaceous-coating procedure disclosed in Example 1.

The two batches of pitch-coated LVP powder were stabilized according to two different methods The 20 g sample was blended with approximately 10 wt % lithium nitrate. The 500 g batch was divided into two portions. The first portion was blended with 10 wt % lithium nitrate. This portion and the 20 g sample were stabilized by gradual heating to 300° C. and held at 300° C. for 2 hours in a nitrogen gas atmosphere. The remaining portion from the 500 g batch of pitch-coated LVP was stabilized by gradual heating to 250° C. and held at 250° C. for 6 hours under reduced air pressure (˜15 inches mercury or ˜50.8 kilopascals).

The 20 g sample and the portion of the 500 g batch material stabilized in air were carbonized at 900° C. in nitrogen gas. The portion of the 500 g batch stabilized with lithium nitrate under a nitrogen atmosphere was further subdivided into three samples which were carbonized in nitrogen gas at 900, 950, or 1000° C., respectively to determine the effect of the method of stabilization and carbonization temperature on the final product. The resulting carbon-coated LMP products stabilized in air were designated as C-LVP-A and the carbon-coated LMP products stabilized with nitrate ion were designated as C-LVP-N.

### B. Electrode Preparation and Test Scheme

Uncoated LVP and C-LVP powders were evaluated with two electrode compositions. One composition contained carbon black, specifically 2% acetylene carbon black, 4% fine graphite (<8 μm), 4% polyvinylidene fluoride (PVDF), and 90% C-LVP or LVP. The other composition contained no carbon black. It was composed of 4% fine graphite (<8 μm), 4% polyvinylidene fluoride (PVDF), and 92% C-LVP or LVP. The mass loading was typically controlled at about 9 mg/cm², and the electrode density was about 2.1 g/cc.

The prepared electrodes were tested at room temperature (˜23° C.) in standard coin cells (size CR2025) with lithium metal as the negative electrode. The test scheme was as follows: the cells were charged under a constant current of 0.5 mA (˜40 mA/g or a C/3 rate) until the cell voltage reached 4.2 volts. The voltage was held at 4.2 volts for one hour or until the current dropped to below 0.03 mA. Then the cell was discharged at constant current of 0.5 mA until the cell voltage reached 3.0 volts. Charge/discharge cycles were repeated over 30 times for cycle life tests.

### C. Comparison of Capacities and Initial Coulombic Efficiencies

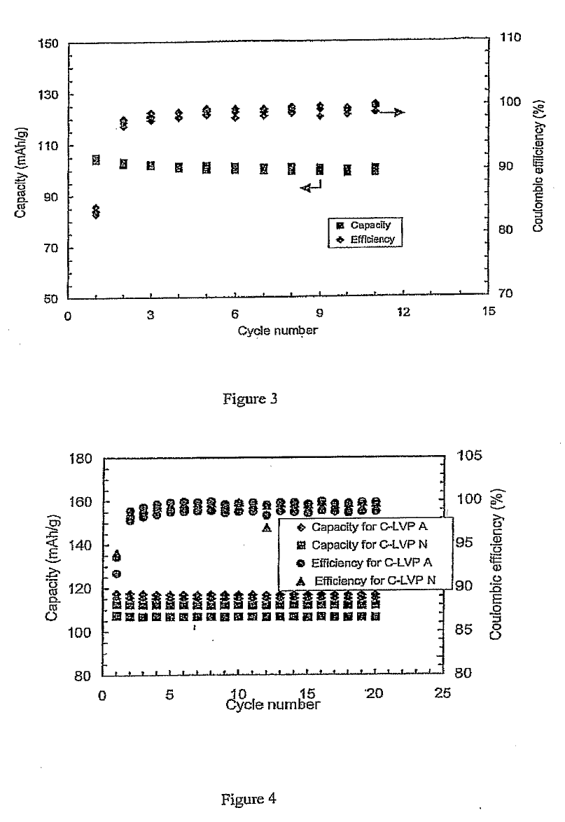

FIGS. 3 and 4 illustrate the capacity and coulombic efficiency at different cycles for coin cells made with cathodes containing uncoated LVP and C-LVP. These electrodes contained 2% carbon black The charge capacity was calculated based on the total LVP or C-LVP mass, including the carbon content of the LVP or C-LVP powders, but excluding the carbon black, graphite, and PVDF used to fabricate the electrode. Uncoated LVP has an initial capacity of ˜104 mAh/g and an initial coulombic efficiency of ˜84%, as shown in FIG. 1. After 10 cycles, the capacity dropped to 100 mAh/g, 3.85% drop in the capacity.

On the first cycle C-LVP powders yielded charge capacities of 117 mAh/g and 110 mAh/g for air stabilized C-LVP and lithium nitrate stabilized C-LVP, respectively. Both powders resulted in a coulombic efficiency of about 94%, as shown in FIG. 4. After 10 cycles, the capacity decreased only about 0.7 mAh/g. The initial charge capacity was calculated to be 124 mAh/g, only 7 mAh/g less than the theoretical value of about 131 mAh/g for extraction of two lithium ions in Li₃V₂(PO₄)₃. Hence, the coating the LVP with carbon enhanced the LVP in three ways: 1) higher initial coulombic efficiency, 2) higher reversible capacity, and 3) significantly longer cycle life.

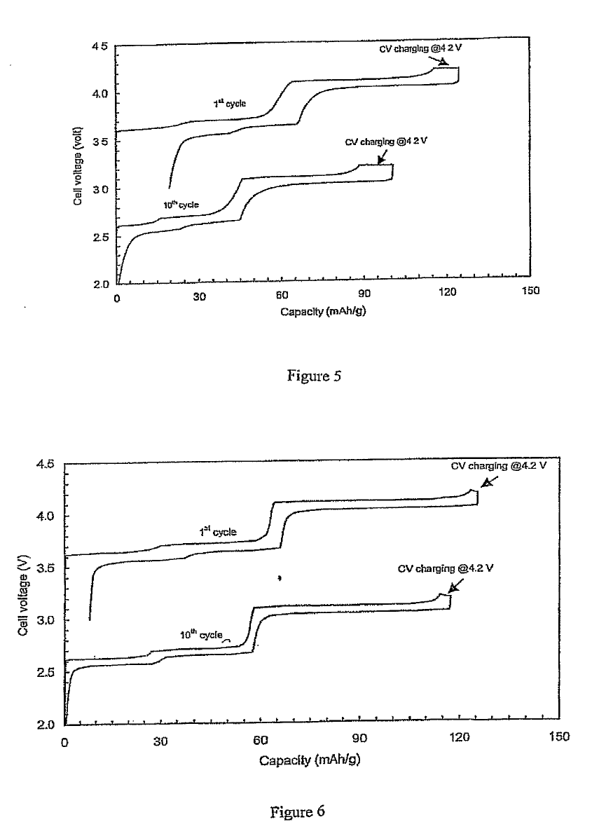

Analysis of the cell voltage profiles during charge/discharge cycles indicated an additional and major benefit of the C-LVP powders, namely faster charging and discharging occurred with the C-LVP powders. FIGS. 5 and 6 show the cell voltage or potential profiles for uncoated LVP and C-LVP electrodes, respectively. Because of the vast excess of Li metal, the rate of oxidation or reduction at the Li metal electrode can be considered constant during the charge and discharge cycles. For both the uncoated LVP and C-LVP electrodes the potential profiles (FIGS. 5 and 6) oh charging and discharging were fairly symmetric. There were three plateaus upon charging and three plateaus upon discharging, indicating that the uncoated LVP material reversibly goes through three phases during the charge and discharge cycle. As a result of various resistances within the cell, there was a fairly large hysteresis between charging and discharging potentials for the uncoated LVP electrode (FIG. 5). The C-LVP electrode, on the other hand, experienced less resistance upon charging and discharging. The potential profiles for the C-LVP electrode were more symmetric with much less hysteresis. (See FIG. 6)

Finally FIG. 5 illustrates there is a significant capacity gain during constant cell voltage (CV) charging at 4.2 volts for the uncoated LVP cells and that the gain in capacity increased during cycling. However, for the C-LVP cell (FIG. 6) there was only a small capacity gain during constant voltage charging at 4.2 volt, which meant that the state of charge of the C-LVP electrode closely followed the amount of charge passed and that the electrode was at a nearly equilibrium condition. Therefore, the kinetics and ionic conduction within the C-LVP powders were relatively fast at the given charging and discharging rates.

### D. Comparison of Cycle Life

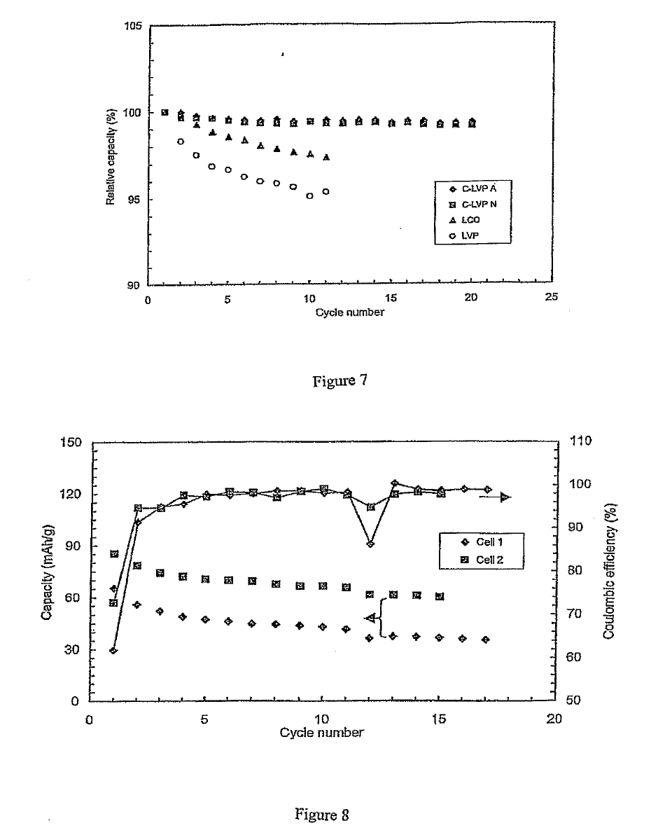

FIG. 7 shows a comparison of relative capacities at different cycles for C-LVP, uncoated LVP, and LiCoO₂ (LCO). The LCO material was a commercially available cathode material for Li-ion batteries (FMC Corporation.) The LCO material was tested under conditions identical to those for the LVP and C-LVP powders. Both the LVP and LCO exhibited moderate to high capacity fading during cycling; however, the C-LVP did not. (The “A” in the legend for C-LVP signifies that the carbonaceous-coated substrate was stabilized in air; the “N” signifies stabilization with nitrate ion.)

### E. Effects of Carbon Black in Electrode Formation and Heat Treatment

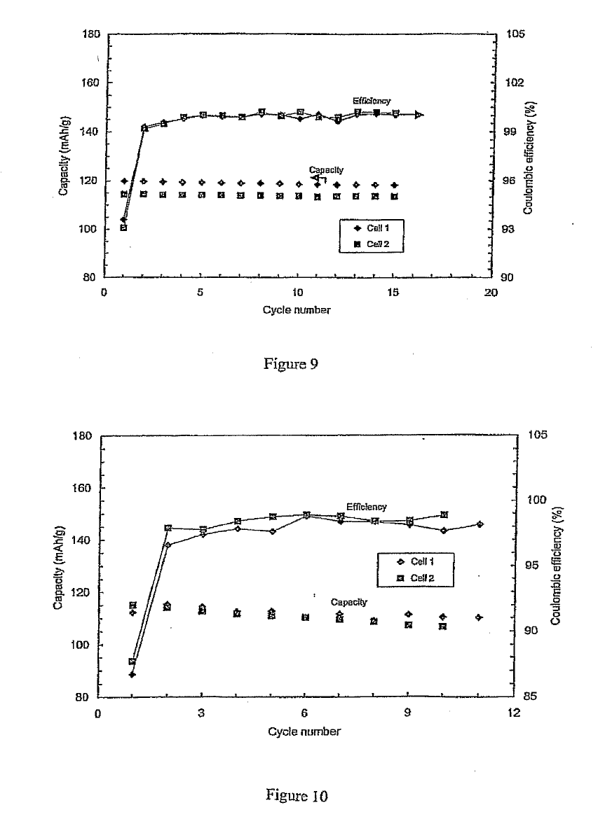

Carbon black is commonly added in the formulation of lithiated inorganic cathodes to aid in conduction. Uncoated LVP and C-LVP electrodes were formulated with and without 2% carbon black. FIGS. 8 and 9 are plots of the charge capacities and coulombic efficiencies at different cycles for the uncoated LVP and C-LVP cathodes, respectively, formulated without carbon black. Without carbon black added to the formulation for the LVP electrode, the capacity and coulombic efficiency dropped significantly as can be seen by comparing FIG. 3 (uncoated LVP with carbon black) with FIG. 6 (uncoated LVP without carbon black). The average initial capacity and coulombic efficiency is 104 mAh/g and 84%, respectively, for the uncoated LVP electrode formulated without 2% carbon black. The addition of carbon black, on the other hand, had little or no effect on the capacity and coulombic efficiency of the C-LVP electrode as can be seen by comparing FIGS. 4 and 9.

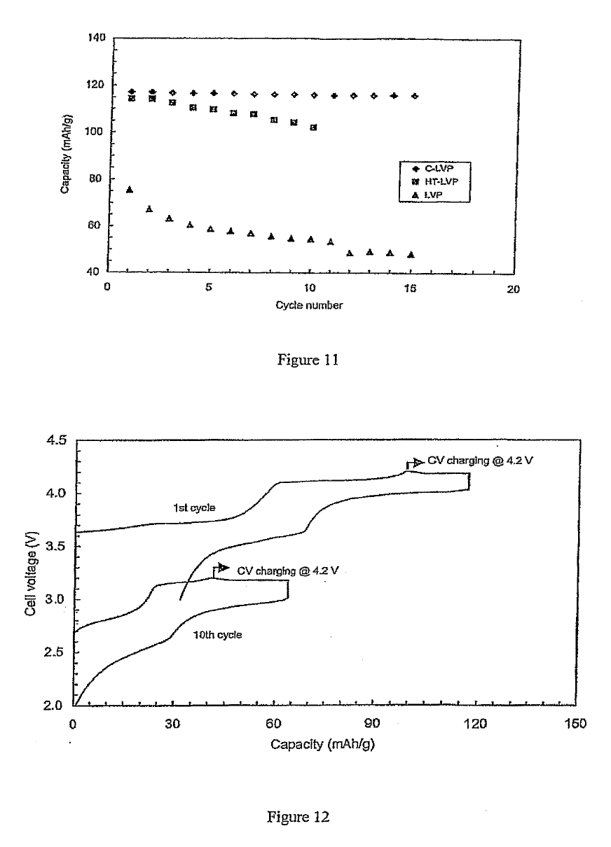

The coating process entailed coating xylene insoluble pitch on a LMP substrate followed by heat treatment steps that render a coating of a carbon on the LMP substrate Heat treatment temperatures of greater than 600° C. yielded a coating of >98% carbon. For C-LVP, 900° C. has been shown to be an efficient final heat treatment temperature following carbonaceous coating using the procedures described above. To ensure that improvements in charge capacity and efficiency of C-LVP were due to the carbon coating, and not the final heat treatment temperature, uncoated LVP was heat treated to 900° C. and fabricated into cathodes. As FIG. 10 depicts, heat treating uncoated LVP to 900° C. increased the charge capacity and first cycle efficiency of the resultant electrodes compared to electrodes made with uncoated LVP that has not been heat treated (FIG. 1). Heat treatment raised the capacity from 76 mAh/g to 114 mAh/g and the coulombic efficiency from 67% to 88%. The capacity-fading rate also was reduced. Nonetheless, charge capacity and efficiency for the heat-treated, uncoated LVP electrodes were still slightly less than the C-LVP electrodes (Compare FIGS. 9 and 10). FIG. 11 gives a comparison of the capacities at different cycles among the three samples. There were clear differences among the samples. The uncoated LVP electrodes performed poorly, while the heat-treated LVP performed better, but the carbonaceous-coated LVP showed the best results. In addition, cells with the C-LVP electrodes exhibited no charge capacity fading over several cycles. (See FIG. 11.)

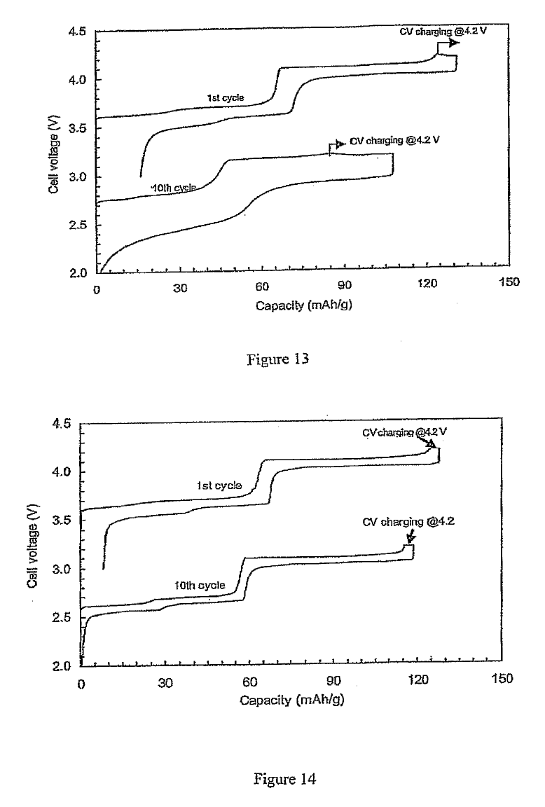

The differences in the capacity and the fading rate between the heat-treated uncoated LVP and carbon-coated LVP powders were apparent, but only marginal. However, the quality of the capacity or the reversibility of charge and discharge process deteriorated rapidly during cycling for the heat-treated uncoated LVP electrode, whereas it did not change for the carbon-coated LVP electrodes. FIGS. 12, 13, and 14 show the cell voltage profiles during charge and discharge cycling at the 1st and 10th cycles, respectively for the three materials (uncoated LVP (LVP), heat-treated uncoated LVP (HT-LVP) and carbon-coated LVP (C-LVP). The symmetric feature and hysteresis between the charging and discharging curves drastically deteriorated from the 1st to the 10th cycles for both uncoated LVP electrodes, as shown in FIGS. 12 and 13. But for the carbon-coated LVP electrodes, the charging and discharging potential profiles remained perfectly symmetric from the 1st cycle to the 10th cycle, as shown in FIG. 14.

Adding carbon black to electrodes made with uncoated LVP was necessary for them to perform reasonably well, but it was not necessary to do so for electrodes made with the carbon-coated LVP materials. Heat treatment improved the performance of the uncoated LVP powder, but the improvement was not significant enough for the material to be competitive with the carbon-coated LVP powders.

Although the present invention and its advantages have been described in detail, it should be understood that various changes, substitutions and alterations may be made herein without departing from the spirit and scope of the invention as defined by the appended claims.

What is claimed is:

1. A process for making a battery cathode material, comprising:
a) providing a lithium metal polyanionic powder;
b) precipitating a carbonaceous material on to the lithium metal polyanionic powder to form a coated lithium metal polyanionic powder;
c) stabilizing the coated lithium metal polyanionic powder at a temperature between about 20° C. and 400° C.; and
d) carbonizing the coated lithium metal polyanionic powder to produce the battery cathode material, wherein both the charge capacity of the battery cathode material and cycle life are improved by at least about 10%.

2. The process of claim 1, wherein the lithium metal polyanionic powder comprises a polyanion containing boron, phosphorous, silicon, aluminum, sulfur, fluoride, chloride or combinations thereof.

3. The process of claim 1, wherein the polyanion comprises BO₃³⁻, PO₄³⁻, AlO₃³⁻, AsCl₄⁻, AsO₃³⁻, SiO₃³⁻, SO₄²⁻, BO₃⁻, AlO₂⁻, SiO₃²⁻, SO₄²⁻, or combinations thereof.

4. The process of claim 1, wherein the lithium metal polyanionic powder comprises a transition metal.

5. The process of claim 1, wherein a) comprises synthesizing the lithium metal polyanionic powder.

6. The process of claim 1, wherein the lithium metal polyanionic powder comprises a mean particle size less than about 10 microns.

7. The process of claim 1, wherein the precipitated carbonaceous material comprises petroleum pitch, coal tar pitch, lignin, or combinations thereof.

8. The process of claim 1, wherein precipitating the carbonaceous material on to the lithium metal polyanionic powder comprises:
a) dispersing the lithium metal polyanionic powder in a suspension liquid to form a lithium metal polyanionic powder suspension;
b) adding a carbonaceous solution to the lithium metal polyanionic powder suspension to form a carbonaceous-lithium metal polyanionic mixture; and
c) reducing the temperature of the carbonaceous-lithium metal polyanionic mixture to precipitate the carbonaceous material on to the lithium metal polyanionic powder.

9. The process of claim 8, wherein the carbonaceous solution is prepared by partially or completely dissolving the carbonaceous material in a solvent.

10. The process of claim 8, wherein the coated lithium metal polyanionic powder comprises between about 0.1% and about 20% by weight carbonaceous material.

11. The process of claim 8, further comprising heating the carbonaceous solution to a temperature between about 20° C. and about 400° C.

12. The process of claim 8, further comprising heating the lithium metal polyanionic powder suspension to a temperature between about 20° C. and about 400° C.

13. The process of claim 8, wherein the carbonaceous solution comprises a weight ratio of carbonaceous material to solvent between about 0.1 and about 2.

14. The process of claim 8, further comprising reducing the temperature of the carbonaceous-lithium metal polyanionic mixture to a temperature between about 0° C. and about 100° C.

15. The process of claim 1, further comprising drying the coated lithium metal polyanionic powder.

16. The process of claim 1, further comprising stabilizing the coated lithium metal polyanionic powder at a temperature between about 20° C. and 400° C. in the presence of an oxidizing agent.

17. The process of claim 1, wherein carbonizing the coated lithium metal polyanionic powder comprises carbonization at a temperature between about 600° C. and about 1,100° C.

18. The process of claim 1, wherein carbonizing the coated lithium metal polyanionic powder is accomplished in the presence of an inert gas.

19. A method of increasing the charge capacity of a lithium metal polyanionic powder comprising:
precipitating a carbonaceous material on the lithium metal polyanionic powder to form a coated lithium metal polyanionic powder; and carbonizing the coated lithium metal polyanionic powder to improve both the charge capacity and cycle life of the lithium metal polyanionic powder by at least 10%.

20. A method of increasing the coulombic efficiency of a lithium metal polyanionic powder comprising:
precipitating a carbonaceous material on the lithium metal polyanionic powder to form a coated lithium metal polyanionic powder; and carbonizing the coated lithium metal polyanionic powder to increase the coulombic efficiency of the lithium metal polyanionic powder by at least 2%.

21. A process for making a battery cathode material, comprising:
a) dispersing a lithium metal polyanionic powder in a suspension liquid to form a lithium metal polyanionic powder suspension;
b) adding a carbonaceous solution comprising pitch to the lithium metal polyanionic powder suspension to form a carbonaceous-lithium metal polyanionic mixture;
c) reducing the temperature of the carbonaceous-lithium metal polyanionic mixture to precipitate the carbonaceous material on to the lithium metal polyanionic powder to form a carbon-coated lithium metal polyanionic powder;
d) stabilizing the coated lithium metal polyanionic powder at a temperature between about 20° C. and 400° C. in the presence of an oxidizing agent; and
e) carbonizing the coated lithium metal polyanionic powder to produce the battery cathode material, wherein both the charge capacity of the battery cathode material and cycle life are improved by at least about 10%.

22. The process of claim 21 wherein the lithium metal polyanionic powder comprises lithium iron phosphate.

23. The process of claim 21 wherein the lithium metal polyanionic powder comprises lithium vanadium phosphate.
